(19) United States
(12) Patent Application Publication
(10) Pub. No.: US 2018/0135324 A1
(43) Pub. Date: May 17, 2018

(54) INFINITY EDGE SWIMMING POOL CLEANER AND METHOD

(71) Applicant: Leif Zars, San Antonio, TX (US)

(72) Inventor: Leif Zars, San Antonio, TX (US)

(21) Appl. No.: 15/350,301

(22) Filed: Nov. 14, 2016

(51) Int. Cl. E04H 4/12; C02F 1/24; E04H 4/16

(52) U.S. Cl. CPC E04H 4/1245; C02F 2103/42; E04H 4/169; C02F 1/24

(57) ABSTRACT

An infinity pool cleaner and a method for cleaning an infinity pool having a blower connected to an inlet in the pool to blow air into the pool near enough to the infinity edge and create bubbles and waves to wash debris over the infinity edge and a controller to periodically activate the blower and create bubbles and waves in the pool to wash debris over the infinity edge.

### CROSS-REFERENCE TO RELATED APPLICATIONS

N/A

### STATEMENTS REGARDING FEDERALLY SPONSORED RESEARCH OR DEVELOPMENT

N/A

### REFERENCE TO A MICROFICHE APPENDIX

N/A

### BACKGROUND OF THE INVENTION

### 1. Field of the Invention

The invention related to infinity edge pools and a cleaning system and method for cleaning infinity edge pools.

### 2. Description of the Related Art

Infinity-edge pools create the appearance of a sheet of water falling off over the edge of the pool, giving swimmers the illusion that they are swimming near the edge of a waterfall. In reality, the edge of the pool is set just slightly below the pool's water level, so that the water spills over into a catch basin or sump. From there it is pumped back into the pool.

An infinity-edge pool is most impressive where the vanishing edge seems to merge with the sky or with a large body of water. For this reason, they are often situated on hillsides overlooking the sea or a lake, or on the rooftops of resort hotels. Their construction usually requires considerable structural engineering and can cost a great deal more than a conventional pool. Infinity-edge swimming pools date back to the 1950s, but infinity-edge spas and fountains have been around for centuries. The concept is thought to have originated in France. An example of an infinity-edge fountain dates back to the early 1600s at the Palace of Versailles.

Infinity-edge pools give the illusion of a sheet of water dropping off over the edge of the property, like a waterfall. The water that spills over the edge, usually into a catch pool or basin or overflow sump a few feet-or-so below the vanishing edge, is recycled back into the swimming pool. To work properly, a disappearing-edge pool requires carefully calculated and maintained water levels, strong, solid construction to support thousands of gallons of water, and a generally level edge over which the water can flow.

While the standard vanishing pool has an edge with a 90-degree angle, infinity edges can take on several different forms. Edges can be sloped, overhanging or stacked stairs. Materials used for edges can be smooth or textured, since swimmers won't be in the catch basin (at least they shouldn't be). On steep slopes, vanishing edges can be 6 feet or more to the sump—the cascading water creates a dramatic water feature when viewed from below the slope or pool.

When it comes to pool maintenance, sometimes infinity pools can be more of a challenge to clean. In a typical, traditional pool, most people would only have to clean and chemically treat the main body of the pool where most of the fun and activity takes place. In the case of an infinity pool, the water flows over the edge to a lower catch basin and carries some floating debris with it. This basin captures the water and debris that comes from the upper level and returns the water back to the upper level. It has a lower suction source so that the water can be suctioned and returned back to the upper level. In addition to taking good care of your basin, pool owners must be sure to watch their water level because infinity pools tend to evaporate more than a standard pool.

It is necessary that you keep water in the sump so it is never empty. You need to cycle that water in with the pool water to keep the chemistry balanced. If the sump is dry or nearly dry, the pumps can pump it empty and lose prime. So you always want to have some amount of water in the sump.

There typically are pumps that are dedicated to moving water from the sump to the pool. That pump is turned on when people are swimming, and even if people are not swimming, you recirculate the water from the sump into the pool so it doesn't get stagnant. Variable speed pumps enable you to vary the amount of water that is pumped during different times of the day and based on the use of the pool so they may be continuously run.

Leaves and other debris collect on the pool surface and typically float for a while and will be directed by the overflowing water to the infinity edge. Some of the debris will be swept over the infinity edge into the sump. However, some debris will not be swept over the infinity edge and can hang up at the infinity edge.

A water body with an infinity edge is basically stating that it has an overflow edge that allows surface water to overflow this edge creating somewhat of a skimming action. This may serve as the skimmer for the pool. This overflow generally empties into some type of a catch basin or overflow sump so as to accumulate the overflow water for recirculation.

In a residential swimming pool, you will generally provide for an eight hour turnover rate which means that a typical 15.000 gallon pool will flow at the rate of 32 gallons per minute. If we have a 20 lineal foot infinity edge overflow flowing at 32 gallons per minute we have approximately ⅛ of an inch of water thickness flowing over the edge during recirculation. Generally this is not sufficient water velocity to carry all floating debris over and beyond this edge.

### BRIEF SUMMARY OF THE INVENTION

The invention comprises a device and system to aid in the cleaning of infinity water features on pools.

A cleaning system is provided for an infinity swimming pool, having a pool section with an infinity edge and a sump section and an air blower to create bubbles in the pool water and waves on the water surface. The blower is connected to the pool by an air supply line and has at least one outlet into the lower portion of the pool to allow injection of air to create bubbles in the water and causes waves on the pool water surface that overflows the infinity edge into the sump section;

A blower is connected to the pool to blow air into an outlet in the lower portion of the pool water and create bubbles that in turn create waves in the pool water surface to wash debris over the infinity edge. A controller activates the blower and creates the waves in the pool surface to wash debris over the infinity edge. The controller may be a timer to periodically activate the blower and create waves in the pool surface to wash debris over the infinity edge. The blower may be connected to the pool section at or close to the bottom near the infinity edge to blow air into the pool water and create waves in the water surface to wash debris over the infinity edge. The blower may be positioned to blow air into the bottom of the pool water near the center and near the infinity wall to create waves in the water surface to wash debris over the infinity edge.

A method is also provided for cleaning an infinity swimming pool, by circulating water in the infinity swimming pool having a pool section with a pool pump and flowing the water over an infinity edge into a sump section. Air is blown into the lower portion of the pool water near the infinity edge to create bubbles that causes waves in the pool surface near the infinity edge to wash debris over the infinity edge. The air may be blown into the bottom of the pool at selected intervals to create the bubbles that cause the waves in the pool surface to wash debris over the infinity edge.

### BRIEF DESCRIPTION OF THE SEVERAL VIEWS OF THE DRAWINGS

FIG. 1 is side view on an infinity pool.

FIG. 2 is a top view of an infinity pool

FIG. 3 is schematic view of the piping and components of the invention on an infinity pool.

FIG. 4 is a partial schematic view of the pool drain with drain lines and air outlet line.

### DETAILED DESCRIPTION OF THE INVENTION

In as much as most of the debris contamination in water bodies come from the surrounding area and enters the pool via the surface of the water, most of this debris is airborne and typically will float for a reasonable period of time before sinking to the pool floor. The theory with this invention is that if you can catch the floating debris before it sinks to the pool floor, you can contain it in the catch basin or sump to consolidate the material in a single location over a period of time. Because of the large size of the sump compared to a skimmer basket, cleaning frequency is greatly reduced.

This invention helps reduce the cost and required maintenance on water bodies by providing a simplified means of enhancing the overflow over the overflow edge. This is designed to be accomplished by the introduction of air bubbles in the lower portion of the water body in near proximity to the overflow edge so as to agitate the surface thus creating waves which in turn will carry the accumulated debris over the edge into the sump.

For conservation purposes the water from the pool overflow or sump is typically recirculated into the main body of water so as to continue the cleaning or water treatment cycle. By making the overflow sump reasonably accessible and with reasonable debris straining capabilities, suction can continue to draw water from this sump for weeks even months before sufficient debris is accumulated to significantly impede the suction flow. When this condition occurs it is anticipated that pool maintenance or janitorial service personnel will remove the accumulated debris from the sump covering several months of debris with one single visit or cleanup. It is anticipated that this reduction of energy and labor will significantly reduce the cost of maintaining such bodies of water.

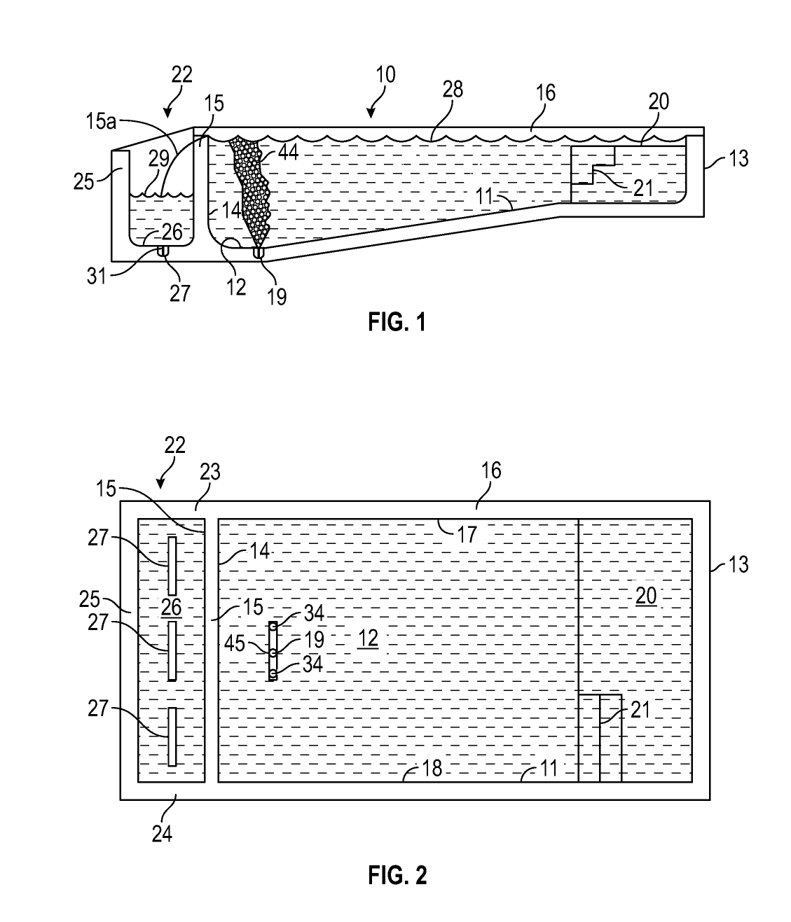

As shown in FIG. 1, there is a standard infinity swimming pool 10 shown in cross-section. In FIG. 2 of the infinity swimming pool is shown in a top view. The infinity swimming pool 10 includes a shallow bottom surface 11 and a deeper bottom surface 12. The pool comprises an end wall 13 and an end infinity wall 14 having a horizontal edge 15 for allowing overflow of water. Sidewalls 17 and 18 are provided and each include a top pool deck edge 16. In the bottom of the pool at the deep end there is provided a pool bottom drain 19. The pool bottom drain is located in the lowest level of the pool in order to effective provide circulation and drainage. The pool may have multiple drain inlets spaced apart along the elongated drain so that a person blocking one of the drain inlets will not be trapped against the drain inlet. The pool may have a shallow entry 20 with pool stairs 21.

An overflow sump 22 is provided at the infinity end adjacent the horizontal infinity edge 15 which allows water overflow 15a into the sump. The overflow sump 22 includes sump sidewalls 23 and 24 and a sump end wall 25. In the sump bottom 26 there are sump drain inlet pipes 27 in an elongated drain that are connected to a common pipe.

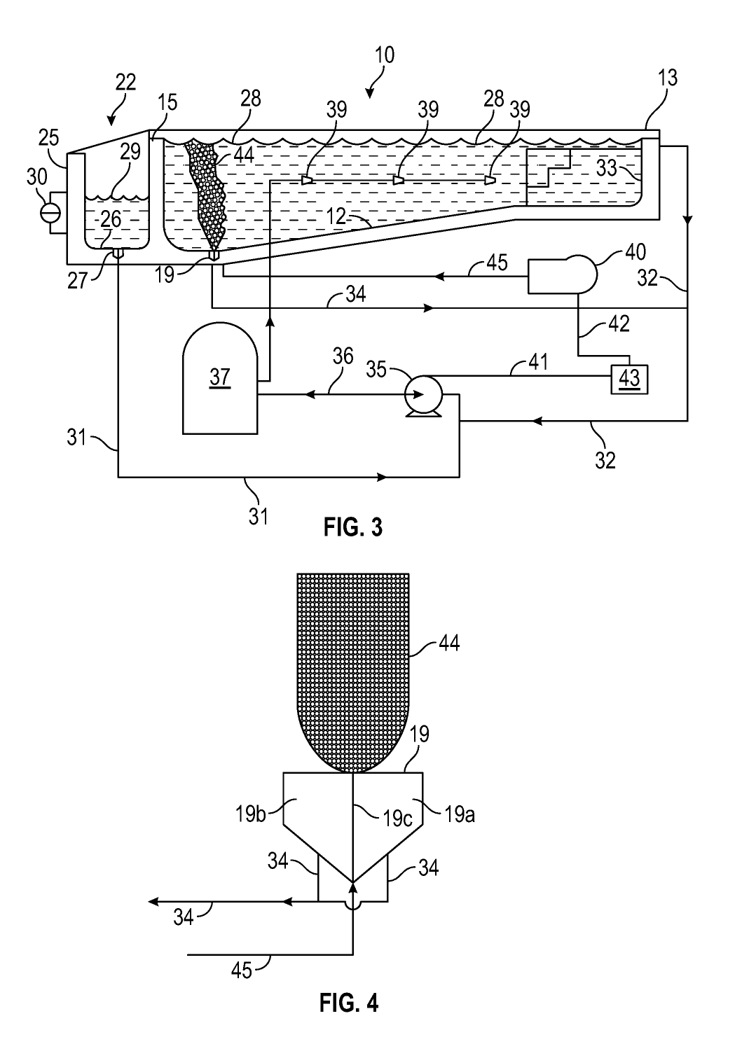

As shown in FIG. 3 the plumbing diagram for the infinity pool 10 is shown schematically. The pool water level 28 is maintained in the pool. The sump water level 29 is maintained in the sump. An automatic sump filler 30 is provided to maintain the water level in the sump and pool. The automatic sump filler may use a standard automatic filler valve to maintain the water level.

Connected to the bottom of the sump and the three sump drain inlets 27 is a drain line 31. The multiple drain inlets 27 allow the collection of more debris in the sump without clogging the drains. The drain line 31 connects to the three drain inlets and extends to the standard pool pump 35. Most of the water that is flowing into the pool comes from the sump line 31 rather than the drain line 34

A pump power line 41 connects the pump 41 to a pool controller 43. With this setup only one pool pump is used. More sophisticated infinity pools may utilize multiple pumps and computerized controller systems so the pool water can be circulated and cleaned without having to flow water over the edge. Instead of a computerized controller system on the swimming pool pump and one could use manual controls. A variable speed pump may be used to vary the amount of water flowing over the infinity edge. A pool that is used more often and has more swimmers may need the more sophisticated pump and controller system. Computer controllers are common and allow remote control of the pool equipment.

Another drain line 32 may be connected to the pump and extend to a standard skimmer 33. The skimmer may be a standard skimmer or it may have an edge trough around the pool that acts as a skimmer. Pools with infinity edge or edges do not require the installation of a mechanical skimmer in as much as the infinity edge provides skimming action.

As shown in FIGS. 3 and 4 the bottom drain 19 is connected with drain lines 19a and 19b to drain line 34 which in turn is also connected to the pump 35. There are two laterally spaced inlet connector lines 19a and 19b connected to the drain line 34. A pump line 36 goes to the filter 37. Valves may be provided to control the water that is supplied to the pump 35 from the lines 31, 32, and 34 and to maintain an adequate flow over the infinity edge. A separate pump may be connected to the line 31 and a separate pump to the lines 32 and 32 to maintain desired water recirculation and flow over the infinity edge.

The bottom drain is shown as an elongated drain with three spaced inlets so that it will not suck a swimmer into the drain and cause accidental drowning if one of the inlets is blocked. Although only one drain with multiple inlets is shown, laterally spaced multiple drains with multiple outlets could be used. Also, if there are multiple infinity edges, multiple air outlets may be required. The air outlet or outlets are spaced from the infinity edge a sufficient amount to create waves with the air that is flowed into the pool. The location and number of outlets may vary depending on the size and depth of the pool. Also, two spaced outlets helped insure that sufficient waves are created by the air bubbles to wash floating debris over the infinity edge. The air outlet or outlets should be spaced a few feet from the infinity edge to allow the propagation of the waves over the infinity edge.

The filter may be a cartridge, sand or diatomaceous earth filter. After passing through the filter 37, the cleaned water passes through the pool inlet line 38 and then enters the pool through pool jets 39. Although only shown on one side, pool jets may be positioned on the pool ends and other side.

A chlorinator is typically used to purify the pool water and prevent algae buildup. This may involve a manual chlorinator that uses chlorine pellets in a floating dispenser or an automatic chlorinator that measures pH and periodically injects chlorine into the water. A salt chlorinator is commonly used with a salt water pool.

A standard air blower 40 is connected to the blower line 45 by the center outlet 19c line of the elongated drain 19 as shown in FIG. 4 to turn the center inlet into an air outlet. A blower power line 42 connects the blower 40 to a pool timer controller 43. The timer connected to the air blower allows the introduction of air bubbles into the pool as represented at 44 periodically during the hours while the swimming pool filter system is running. The timer 43 may be a standard mechanical timer, electronic timer and a computerized timer that provides a multiple unit controller to automatically control the blower 40 and pump 35. The air line 45 could also be connected to a separate outlet into the pool 10 if an extra inlet in an elongated drain is not used. The air outlet into the pool is preferably centrally located between the two sides of the pool so that it directed the air bubbles upwardly in proximity to the vanishing edge 15. This creates the waves at the vanishing edge 15 to cause any floating debris to wash over the vanishing edge 15 into the sump 22.

The air outlet line is located near enough to the infinity edge to create the bubbles and waves to wash any debris over the infinity edge. Typically, this is near the bottom drain on a pool that is designed with a deep end adjacent the sump. Some pools have a central drain or a drain that is near one side. When the pool drain is not centrally located or in close enough proximity to the infinity edge, one or more separate outlets can be provided in the lower surface of the pool spaced a few feet from the infinity edge. The blower size and speed can be selected to create sufficient bubble and waves to wash floating debris over the infinity edge. A variable or multiple speed blower can be used to adjust the amount of air to match the needs of the pool. The location of the air outlet and number of air outlets may vary based on the design of the pool including the depth, shape and locations of one or more infinity edges.

The infinity pool 10 is conventional except for the addition of the blower outlet 19c being strategically positioned and operated to periodically direct air bubbles into the pool to create waves in the water surface to wash debris over the infinity edge. The air bubbles create waves in the water surface 28. The waves assist in washing any floating debris over the infinity edge 15.

In operation the pump 35 pulls water from mostly from the sump 22 and some from the pool 10 and passes it through the filter 37 and injects it back into the pool through the pool inlets or jets 39. The water level controller 30 maintains the water lever such that the water overflows the horizontal edge 15 of the infinity wall 14 to give the illusion of an infinity wall or waterfall when the pump is operated to circulate water. Water must be periodically added to the pool to compensate for evaporation.

In operation the debris that falls into the pool which may be in the form of leaves or floating twigs or other debris is intended to flow over the horizontal edge 15 with the flowing water and into the sump 22 where it must be cleaned. However, some of the debris often hangs on the edge 15 and does not flow over the edge 15 and down into the sump 22. The debris that hangs at the infinity edge appears unsightly.

To help facilitate the flow of the debris over the horizontal edge 15, the blower 40 is periodically activated, for instance every two hours, for a short period of time, 15 to 30 seconds, to create rapid air flow through the line 45 and out the drain 19 in the form of air bubbles 44 as shown in FIG. 3. These air bubbles create waves in the water and these waves help splash debris over the horizontal edge 15 and wash the debris over the edge into the sump 22 for standard cleaning. The drain 19 is often positioned in a pool so that it can be used as an injection point of air into the pool to create the bubbles and the waves. An important feature is that a blower introduces air into the pool at a location that propagates waves over the infinity edge of the pool to wash debris over the infinity edge.

Generally, there is a main drain in the pool as well as a main drain in the horizon edge sump, so that the swimming pool pump suction can be from either. In normal operation it will pull suction mostly from the horizon edge sump. The water is directed back into the pool forcing return water to overflow into the horizon edge to continue the pool flow.

The constant over flow into the horizon edge of all the filtered water does bring a certain amount of debris over the edge into the sump. However larger floating material such as leaves, twigs and so forth will hang up on the edge and not flow over into the sump, therefore the benefits of the bubbler system, which creates bubbles periodically, is that the bubbles create the waves which in turn induce the floating trash to flow on over the edge into the sump.

You do not have to connect the air supply from the blower to one of the inlets on the bottom drain. It will also work if you connect it to an outlet at or near the bottom of the pool near the main drain of the pool. The outlet for the air bubbles can also be at other locations near the deep end of the pool so it creates bubbles are and waves to induce the trash to tumble over the horizon edge. Connecting the air to the side of the pool could be done however it would create bubbles just on that side and may not be as effective as creating bubbles more or less in the middle of horizon edge 15 so the bubbles would move to both sides instead of on just one side.

An important feature is that a blower introduces air into the pool at a location that creates waves over the infinity edge of the pool to wash over debris.

The invention will work with a typical plumbing schematic of a swimming pool with a horizon edge also referred to as an infinity edge. Generally there is a main drain in the pool as well as a main drain in the horizon edge sump, so that the swimming pool pump suction can be from either. In normal operation it will pull suction only from the horizon edge sump. Forcing all return water to overflow into the horizon edge at all times.

The constant over flow into the horizon edge of all the filtered water does bring a certain amount of debris over the edge into the sump. However larger floating material such as leaves, twigs and so forth often hang up on the edge and not flow over into the sump. This is solved with the benefits of the bubbler system of the invention which then creates bubbles periodically and the bubbles create the waves which in turn induce the trash to go on over the edge into the sump.

As another example the sump can be about 18 inches below the top of the pool. With this setup only one pump is needed. There is no requirement for a timer on the swimming pool pump. Except perhaps as an economical move so that it might shut off during the night hours. There is however a timer on the air pump, so as to introduce air bubbles perhaps every two hours during the hours when the swimming pool filter system is running.

You do not necessarily need to connect the air to the bottom drain line. It is preferred to connect it to the bottom of the sump that serves as the main drain of the pool, or any other general location in the deep end of the pool so it cause the bubbles to be created to induce the waves that caused the trash to tumble over the horizon edge. Connecting the air to the side of the pool could be done however it would create bubbles just on that side and may not be as effective as creating bubbles generally in the middle of the horizon edge so the bubbles would move to both sides instead of on just one side.

Regarding the introduction of air for the creation of the bubbles to create the wave turbulence, this can be scheduled to occur for periods of time of approximately 30 to 45 seconds in duration and sequenced to occur every once every 60 to 90 minutes during recirculation, depending upon the propensity for the accumulation of debris from the surroundings. The means of creating the wave action for overflow is the introduction of air in the lower water portions of the water body in the general vicinity of the overflow edge or edges as the case may be. The air for the air bubbles can be easily created by an inexpensive spa air blower or similar device sized to provide bubbles of sufficient size to create suitable wave turbulence.

You can catch the debris that enters the water body through the surface before it has an opportunity to sink and settle to the pool floor. This accumulated floating debris is far easier to collect and accumulate and remove every several months rather than having a daily chore of water body maintenance through floor brushing or vacuuming.

The above-listed sections and included information are not exhaustive and are only exemplary or the invention. The particular sections and included information in a particular embodiment may depend upon the particular implementation and the included devices and resources. Although a system and method according to the present invention have been described in connection with the preferred embodiments, it is not intended to be limited to the specific form set forth herein, but, on the contrary, it is intended to cover such alternatives, modifications, and equivalents, as can be reasonably included within the spirit and scope of the invention as defined by the appended claims.

We claim:

1. A cleaner for an infinity edge swimming pool, comprising:
An infinity edge swimming pool having a pool section with an infinity edge and a sump section;
At least one pool pump is connected to the infinity edge swimming pool to circulate water in the infinity edge swimming pool and over the infinity edge into the sump section;
A blower connected to an outlet in the lower portion of the infinity edge swimming pool to blow air bubbles into the pool in proximity to the infinity edge to create bubbles and waves in the water surface next to the infinity edge to wash floating debris over the infinity edge;
A controller to activate the blower and create the bubbles and waves in the pool surface to wash debris over the infinity edge.

2. The infinity pool cleaner of claim 1, where:
The blower is connected with an outlet in the pool drain to blow air into the pool water and create waves in the water surface to wash debris over the infinity edge.

3. The infinity pool cleaner of claim 1, where:
The blower is connected to the pool at the bottom surface spaced below the infinity edge to blow air into the pool water and create bubbles and waves in the water surface to wash debris over the infinity edge.

4. The infinity pool cleaner of claims 1, 2 and 3, where:
The controller is a timer to periodically activate the blower and create bubbles and waves in the pool surface to wash debris over the infinity edge.

5. The infinity pool cleaner of claim 1, where:
The blower is connected to blow air into at least two pool outlets near enough to the center and below the infinity wall to create bubbles and waves in the water surface to wash debris over the infinity edge.

6. The infinity pool cleaner of claim 1, where:
The blower is connected to the pool to blow air into at least one pool outlet near below the infinity wall to create bubbles and waves in the water surface to wash debris over the entire length of the infinity edge.

7. The infinity pool cleaner of claim 1, where:
The blower is connected to blow air into a pool outlet near enough to the center and below the infinity wall to create bubbles and waves in the water surface to wash debris over the infinity edge.

8. A method of cleaning an infinity swimming pool, comprising the steps of:
Circulating water in an infinity swimming pool having a pool section with a pool pump and flowing the water over an infinity edge into a sump section;
Blowing air though and outlet in the bottom of the pool to create bubbles and waves in the pool surface near enough to the infinity edge to wash debris over the infinity edge.

9. The method of claim 8, including the steps of:
Blowing air into a bottom outlet of the pool at selected intervals to create bubbles and waves in the pool surface to wash debris over the infinity edge.

10. The method of claim 8, including the steps of:
Blowing air into at least one outlet in the pool drain at selected intervals to create bubbles and waves in the pool surface to wash debris over the entire length of the infinity edge.

11. The method of claims 8, 9 and 10, including the steps of:
Periodically blowing air into the pool at selected times intervals while a pump is circulating water in the pool over the infinity edge to create bubbles and waves in the pool surface to wash debris over the infinity edge.

12. The method of claim 8, including the steps of:
Periodically blowing air into the pool at a location spaced from the infinity edge at selected intervals to create bubbles and waves in the pool surface to wash debris over the infinity edge.

13. The method of claim 8, including the steps of:
Periodically blowing air into the bottom of the pool spaced from the infinity edge at selected intervals to create bubbles and waves in the pool surface to wash debris over the infinity edge.

14. The method of claim 8, including the steps of:
Periodically blowing air into the bottom of the pool spaced from the infinity edge to create bubbles and waves in the pool surface to wash debris over the infinity edge.
